(19) United States
(12) Patent Application Publication
(10) Pub. No.: US 2023/0159398 A1
(43) Pub. Date: May 25, 2023

(54) CEMENT MIXTURES FOR PLUGGING MULTICELLULAR FILTER BODIES AND METHODS OF MAKING THE SAME

(71) Applicant: CORNING INCORPORATED, CORNING, NY (US)

(72) Inventors: Weimin Hou, Shanghai (CN); Patrick David Tepesch, CORNING, NY (US); Qing Zhou, Shanghai (CN)

(21) Appl. No.: 17/976,324

(22) Filed: Oct. 28, 2022

Related U.S. Application Data
(60) Provisional application No. 63/281,111, filed on Nov. 19, 2021.

(51) Int. Cl. C04B 38/00; C04B 14/30; C04B 26/28; C04B 38/06; B01D 46/24; B01D 46/00

(52) U.S. Cl. CPC C04B 38/0012; C04B 14/306; C04B 14/303; C04B 14/305; C04B 26/285; C04B 38/0645; B01D 46/244; B01D 46/0001; B01D 2279/30

(57) ABSTRACT

A cement mixture for application to a honeycomb body and a method of forming a plugged ceramic honeycomb body is provided. The cement mixture contains a plurality of inorganic particles including at least about 50% of a refractory material selected from at least one of alumina and zirconia and less than about 15% titania (by weight), a pore forming agent, an organic binder, and a liquid vehicle.

### CROSS-REFERENCE TO RELATED APPLICATION

This application claims the benefit of priority under 35 U.S.C. §119 of U.S. Provisional Application Ser. No. 63/281,111 filed on Nov. 19, 2021, the content of which is relied upon and incorporated herein by reference in its entirety.

### FIELD

The present disclosure generally relates to cement mixtures for plugging honeycomb bodies, and more particularly for cement mixtures useful for plugging green honeycomb bodies.

### BACKGROUND

Multicellular ceramic bodies, such as for example ceramic honeycombs, can be utilized as a catalyst support or filter for the removal of certain pollutants from exhaust gases, such as diesel or combustion engine exhaust. Multicellular ceramic bodies typically contain a plurality of generally parallel channels defined by cells formed by a matrix or array of thin intersecting ceramic walls or webs. The ceramic walls provide surfaces for exhaust gas filtration and/or for the support of catalysts to reduce the pollutant content of the exhaust gas. Multicellular ceramic bodies used in filtration applications typically have ceramic channel walls that are porous and are often selectively plugged to provide wall-flow filtration flow paths through the honeycomb body.

Multicellular ceramic bodies may be formed by mixing powdered ceramic precursor materials with a binder and optional solvent to form a ceramic precursor mixture that can be shaped to form a green body. For example, the ceramic precursor mixture can be extruded through a die to form a shaped, wet green honeycomb body. The wet, green body is typically dried to remove liquid constituents and then fired at high temperature in a furnace or kiln to convert the raw material in the ceramic precursor mixture to a desired ceramic phase and structure. In some applications, the honeycomb body is plugged after firing with a flowable cement mixture that is filled into the cell channels at the end faces of the body to arrange the body as a particulate filter.

There is a continued need for cement mixtures and methods of use for forming plugged multicellular ceramic bodies with improved processing time.

### SUMMARY

According to an aspect of the present disclosure, a cement mixture for application to a honeycomb body is provided. The cement mixture contains a plurality of inorganic particles comprising at least about 50% of a refractory material selected from at least one of alumina and zirconia and less than about 15% titania (by weight), a pore forming agent, an organic binder, and a liquid vehicle.

According to another aspect of the present disclosure, a honeycomb body having a honeycomb structure that comprises intersecting porous walls of a ceramic material that define channels extending from a first end to a second end is provided. A plugging material is disposed in at least a portion of the channels and at least one of the first end and second end, wherein the plugging material comprises at least about 50% of a refractory material selected from at least one of alumina and zirconia (by weight) and less than about 15% titania (by weight).

According to yet another aspect of the present disclosure, a method of forming a plugged ceramic honeycomb body is provided. The method comprises providing a first green honeycomb structure comprising intersecting walls of a ceramic precursor material that define channels extending from a first end to a second end, wherein the ceramic precursor material comprises an aluminum containing oxide. A cement mixture is selectively inserted into at least one of the first end and second end of the first green honeycomb structure to form a first plugged green honeycomb structure, wherein the cement mixture comprises at least about 50% of a refractory material selected from at least one of alumina and zirconia (by weight) and less than about 15% titania (by weight). The first plugged green honeycomb structure is heated to a first temperature to convert the ceramic precursor material and the cement mixture into a sintered phase ceramic material to form a first plugged ceramic honeycomb structure.

These and other aspects, objects, and features of the present disclosure will be understood and appreciated by those skilled in the art upon studying the following specification, claims, and appended drawings.

### BRIEF DESCRIPTION OF THE DRAWINGS

The following is a description of the figures in the accompanying drawings. The figures are not necessarily to scale, and certain features and certain views of the figures may be shown exaggerated in scale or in schematic in the interest of clarity and conciseness.

In the drawings:

FIG. 1 is a perspective view of an end plugged honeycomb body, according to an aspect of the disclosure;

FIG. 2 is a flowchart illustrating a method of forming a plugged ceramic honeycomb body with a cement mixture, according to an aspect of the present disclosure;

FIG. 3 is a perspective view of a first end plugged honeycomb structure stacked on a second end plugged honeycomb structure such that a central axis of the first end plugged honeycomb structure is generally aligned with a central axis of the second end plugged honeycomb structure, according to an aspect of the present disclosure;

FIG. 4 is a perspective view of a first end plugged honeycomb structure stacked on a second end plugged honeycomb structure such that a central axis of the first end plugged honeycomb structure is offset with respect to a central axis of the second end plugged honeycomb structure, according to an aspect of the present disclosure;

FIG. 5 is a plot of temperature as a function of time for a firing process to convert a ceramic precursor material and an exemplary cement mixture into a sintered phase ceramic material to form a plugged ceramic honeycomb structure, according to aspects of the present disclosure;

FIG. 6 is a plot illustrating the degree of sticking between stacked plugged ceramic honeycomb structures after firing that have been plugged with an exemplary cement mixture containing zirconia (Ex. 1A) or alumina (Ex. 1B) or a comparative cement mixture containing cordierite (Comp. Ex. 1C), according to aspects of the present disclosure;

FIG. 7 is a scanning electron microscope (SEM) image of a stacked plugged honeycomb structure after firing that has been plugged with a comparative cement mixture containing cordierite (Comp. Ex. 1C) illustrating sintering between adjacent portions of the plugging material and honeycomb structure web, according to aspects of the present disclosure;

FIG. 8 is an elemental mapping analysis for magnesium (Mg), aluminum (Al), and silicon (Si) obtained using SEM images of a stacked plugged honeycomb structure after firing that has been plugged with an exemplary cement mixture containing a low purity alumina (Ex. 3A), which shows no observable interaction between the honeycomb structure web and the plugging material, according to aspects of the present disclosure;

FIG. 9 is a plot illustrating the degree of sticking between stacked plugged honeycomb structures after firing that have been plugged with exemplary cement mixtures containing alumina, according to aspects of the present disclosure;

FIG. 10 is a plot illustrating the dimensional stability of the stacked plugged honeycomb structures of FIG. 9 after separation, according to aspects of the present disclosure;

FIG. 11 illustrates a cross-sectional view of a plurality of plugs of the stacked plugged honeycomb structures of FIGS. 9-10, according to aspects of the present disclosure; and

FIG. 12 illustrates plug strength as a function of plug depth for the stacked plugged honeycomb structures of FIGS. 9-10, according to aspects of the present disclosure.

### DETAILED DESCRIPTION

Additional features and advantages will be set forth in the detailed description which follows and will be apparent to those skilled in the art from the description, or recognized by practicing the embodiments as described in the following description, together with the claims and appended drawings.

In this document, relational terms, such as first and second, top and bottom, and the like, are used solely to distinguish one entity or action from another entity or action, without necessarily requiring or implying any actual such relationship or order between such entities or actions.

Modifications of the disclosure will occur to those skilled in the art and to those who make or use the disclosure. Therefore, it is understood that the embodiments shown in the drawings and described above are merely for illustrative purposes and not intended to limit the scope of the disclosure, which is defined by the following claims, as interpreted according to the principles of patent law, including the doctrine of equivalents.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to.

Unless otherwise noted, the terms “substantial,” “substantially,” and variations thereof as used herein are intended to note that a described feature is equal or approximately equal to a value or description. Moreover, “substantially” is intended to denote that two values are approximately equal or even equal.

Directional terms as used herein—for example up, down, right, left, front, back, top, bottom—are made only with reference to the figures as drawn and are not intended to imply absolute orientation.

As used herein, a “wt %,” “weight percent,” or “percent by weight” of a component, unless specifically stated to the contrary, is based on the total weight of the cement mixture in which the component is included, unless otherwise specified.

As used herein, the term “optional” or “optionally” means that the subsequently described event or circumstance may or may not occur, and that the description includes instances where said event or circumstance occurs and instances where it does not.

The terms “free” and “substantially free” are used interchangeably herein to refer to an amount and/or an absence of a particular component in a mixture or composition that is not intentionally added to the mixture or composition. Accordingly, a mixture “free” or “substantially free”, as referred to herein, can contain traces of a particular constituent component as a contaminant in an amount of less than 0.10 wt %.

“Plug strength,” as reported and used herein, was measured using an ALLIRUS 500N force gauge. The material to be measured was placed into the measurement channel and the force required to push the material out of the channel was recorded in Newtons (N). A higher force is indicative of a higher plug strength. It is understood that plug strength can be measured using other methods and/or equipment and appropriate scaling can be applied for comparison with the values reported herein.

“Cement viscosity,” as reported herein, was measured using a ball push test set-up that used a force gauge configured to push a 1 inch ball into the cement at a rate of 6 inches per minute. A higher ball push force (measured in kilogram-force, “kgf”) is indicative of a higher cement viscosity.

Aspects of the present disclosure relate to combinations of apparatus components, materials, and method steps relating to cement mixtures for use with multicellular filter bodies. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

Aspects of the present disclosure relate to cement mixtures containing at least about 50% of a refractory material selected from at least one of alumina and zirconia and less than about 15% titania (by weight) for use with a honeycomb body. In some aspects, the cement mixture can be used as a green body plug mixture for plugging a green honeycomb body prior to firing. Plugging the green honeycomb body prior to firing to form a ceramic honeycomb body can provide a simplified process in which the plug mixture and the honeycomb body are fired in a single step. In some aspects, the cement mixture can be used to form plugs in green filter bodies that are stacked during firing, and which can be separated after firing with low sticking between stacked filter bodies and/or minimal damage to the filter bodies. During a typical firing process, the green filter bodies are placed separately into a furnace, with each honeycomb body placed on a cookie. This firing process can often require multiple days to convert the green honeycomb body into a ceramic honeycomb body having the desired ceramic phases and structure. Firing multiple green filter bodies in stacked layers could increase the firing capacity of the furnace and thus decrease the processing time for producing ceramic filter bodies (e.g., by increasing the number of parts that can be fired in the furnace at a time). However, when green filter bodies are stacked on top of one another during firing, there is a possibility that the stacked filter bodies will stick or sinter together. In some cases, the stacked ceramic filter bodies may be so tightly adhered to one another that a significant amount of force and/or tools are required to separate the stacked filter bodies. This may make it difficult to separate the stacked ceramic filter bodies after firing without damaging the adjacent ends of the stacked ceramic filter bodies. Aspects of the present disclosure relate to a cement mixture that can be used to plug a green honeycomb body which can be stacked with a similar plugged green honeycomb body, fired, and then separated with less force and/or less damage to the adjacent ends of each honeycomb body. In this manner, processing time can be improved by firing the green plug and honeycomb body in a single firing process and/or by allowing for stacking of the plugged green honeycomb body, thereby increasing the firing capacity of the furnace.

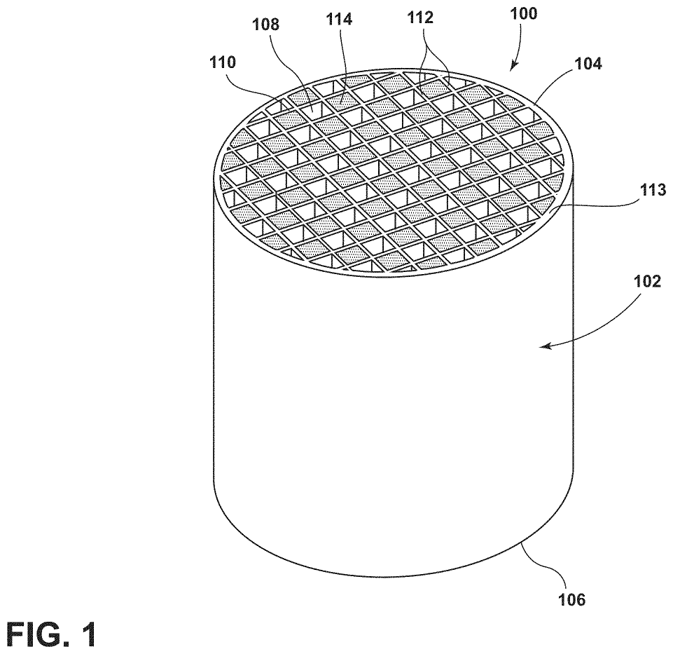

Referring now to FIG. 1, an exemplary end plugged honeycomb body 100 is shown. As illustrated, the honeycomb body 100 (interchangeably, particulate filter or wall flow filter) comprises a honeycomb structure 102 that has a first end 104 (e.g., upstream inlet end) and a second end 106 (e.g., downstream outlet), and a multiplicity of cells 108 (inlet cells) and 110 (outlet cells) extending longitudinally from the first end 104 to the second end 106 forming cell channels that extend between the first and second ends 104 and 106. The multiplicity of cells 108 and 110 are formed from intersecting porous cell walls 112 and are surrounded by an exterior perimeter wall 113. A first portion of the plurality of cell channels are plugged with end plugs 114 at the second end 106 (not shown) to form the inlet cell channels 108 and a second portion of the plurality of cell channels are plugged at the first end 104 with the end plugs 114 to form the outlet cell channels 110. The exemplified plugging configuration forms alternating inlet and outlet cell channels (108 and 110, respectively) such that a fluid stream flows into the honeycomb body 100 through the open cells 108 at the first end 104, then through the porous cell walls 112, and out of the honeycomb body 100 through the open cells 110 at the second end 106. The exemplified end plugged cell configuration can be referred to herein as a “wall flow” configuration since the flow paths resulting from alternate channel plugging directs a fluid stream being treated to flow through the porous ceramic cell walls 112 prior to exiting the honeycomb body 100. Particulate matter in the fluid stream unable to pass through the porous walls 112 will be trapped in the inlet cell channels 108.

The honeycomb structure 102 can be formed from a material suitable for forming a porous monolithic honeycomb body. For example, in one embodiment, the honeycomb structure 102 is formed by shaping a plasticized ceramic precursor mixture (alternatively referred to as a precursor batch mixture) into a green body of the desired honeycomb configuration, and then firing the shaped green body. Exemplary ceramic precursor mixtures can include those for forming cordierite, aluminum titanate, silicon carbide, mullite, or other ceramic phases, aluminum oxide, zirconium oxide, titania, silica, magnesia, niobia, ceria, vanadia, silicon nitride, or any combination thereof.

It is understood that one of ordinary skill in the art will be able to determine and optimize a desired ceramic precursor mixture suitable for forming a particularly desired ceramic honeycomb structure 102 without requiring any undue experimentation. For example, the ceramic precursor components can be selected so as to yield a ceramic honeycomb structure 102 comprising cordierite, mullite, spinel, aluminum titanate, or a mixture thereof upon firing. For example, and without limitation, in one aspect, the ceramic precursor components can be selected to provide a cordierite composition containing from about 49 wt % to about 53 wt % SiO₂, from about 33 wt % to about 38 wt % Al₂O₃, and from about 12 wt % to about 16 wt % MgO. To this end, an exemplary inorganic cordierite precursor batch mixture preferably comprises about 33 wt % to about 41 wt % of an aluminum oxide source, about 46 wt % to about 53 wt % of a silica source, and about 11 wt % to about 17 wt % of a magnesium oxide source. In another example, the ceramic precursor components can be selected to provide, upon firing, an alumina titanate composition containing from about 8 wt % to about 15 wt % SiO₂, from about 45 wt % to about 53 wt % Al₂O₃, and from about 27 wt % to about 33 wt % TiO₂. An exemplary aluminum titanate precursor batch mixture can contain approximately 10 wt % of a silica forming source (such as quartz), approximately 47 wt % of an alumina forming source (such as alpha-alumina), approximately 30 wt % titania, and approximately 13 wt % additional inorganic additives. In yet another embodiment, the ceramic precursor components can be selected to provide, upon firing, a mullite composition containing from about 27 wt % to about 30 wt % SiO₂, and from about 68 wt % to about 72 wt % Al₂O₃. An exemplary mullite precursor batch mixture can comprise approximately 76 wt % of a mullite refractory aggregate, approximately 9 wt % fine clay, and approximately 15 wt % alpha alumina.

The honeycomb structure 102 can be formed according to any conventional process suitable for forming honeycomb monolith bodies. For example, in one embodiment a plasticized ceramic precursor batch can be shaped into a green body by any known conventional ceramic forming process, such as, e.g., extrusion, injection molding, slip casting, centrifugal casting, pressure casting, dry pressing, and the like. Typically, a ceramic precursor batch mixture comprises inorganic ceramic precursor batch component(s) capable of forming, for example, one or more of the sintered phase ceramic compositions set forth above, a liquid vehicle, a binder, and one or more optional processing aids and additives including, for example, lubricants, and/or a pore former. In one aspect, extrusion can be done using a hydraulic ram extrusion press, a two stage de-airing single auger extruder, or a twin screw mixer with a die assembly attached to the discharge end.

The honeycomb structure 102 can have any suitable cell density, such as a cell density of from about 70 cells/in² (10.9 cells/cm², which my alternatively be referred to as “cells per square inch,” or “cpsi”) to about 400 cells/in² (62 cells/cm²). Still further, as described above, a portion of the cells 110 at the first end 104 are plugged with end plugs 114 of a cement mixture (also referred to as a cement mixture). The plugging can be performed only at the ends of the cells 108, 110, although in some embodiments, plugs can be present at locations within the cell channels 108, 110 of the honeycomb structure 102 that are spaced from the end faces 104, 106. In some embodiments, the plugs 114 extend along the cell channels to a depth (e.g., axial length, with respect to the longitudinal axis of the honeycomb structure) of about 3 mm to about 25 mm, although other depths can be used. A portion of the cells 108 on the second end 106 but not corresponding to cells 110 on the first end 104 may also be plugged in a similar pattern. Therefore, each of the cells 108, 110 is preferably plugged only at one of the first end 104 or the second end 106. In one exemplary arrangement, every other cell 108, 110 on a given end 104, 106 is plugged in a checkered pattern as shown in FIG. 1. Further, the inlet and outlet channels 108, 110 can be any desired shape, such as rectangular, triangular, circular, ellipsoidal, hexagonal, octagonal, or other polygon, optionally with chamfered, rounded, or filleted corners. In the exemplary embodiment shown in FIG. 1, the cell channels 108, 110 have a square cross-sectional shape.

Referring again to FIG. 1, once the honeycomb structure 102 is formed, the plugged honeycomb body 100 can be made through the formation of the end plugs 114 in the desired cell channels 108, 110. The end plugs 114 can employ the cement mixtures of the present disclosure. In some aspects, the cement mixtures of the present disclosure for forming end plugs contain: a plurality of inorganic particles comprising at least about 50 wt % of a refractory material selected from alumina and/or zirconia and less than about 15 wt % titania. In some aspects, the cement mixtures can also comprise a pore forming agent, an organic binder, and/or a liquid vehicle.

According to aspects of the present disclosure, a total amount of the plurality of inorganic particles in the cement mixture (i.e., the amount of refractory material plus the amount of titania) is at least about 40 wt %. In some aspects, total amount of the plurality of inorganic particles in the cement mixture is at least about 40 wt %, at least about 45 wt %, at least about 50 wt %, at least about 55 wt %, or at least about 60 wt %. For example, the total amount of the plurality of inorganic particles can be from about 40 wt % to about 65 wt %, about 40 wt % to about 60 wt %, about 40 wt % to about 55 wt %, about 40 wt % to about 50 wt %, about 40 wt % to about 45 wt %, about 45 wt % to about 65 wt %, about 45 wt % to about 60 wt %, about 45 wt % to about 55 wt %, about 45 wt % to about 50 wt %, about 50 wt % to about 65 wt %, about 50 wt % to about 60 wt %, about 50 wt % to about 55 wt %, about 55 wt % to about 65 wt %, about 55 wt % to about 60 wt %, or about 60 wt % to about 65 wt %. In some examples, the total amount of the plurality of inorganic particles is about 40 wt %, about 42 wt %, about 45 wt %, about 46 wt %, about 47 wt %, about 48 wt %, about 49 wt %, about 50 wt %, about 55 wt %, about 56 wt %, about 57 wt %, about 58 wt %, about 59 wt %, about 60 wt %, about 61 wt %, about 62 wt %, about 65 wt %, or any amount between these values.

According to some aspects of the present disclosure, the refractory material can be alumina, zirconia, or a combination thereof. In some examples, the refractory material contains alumina and is substantially free of zirconia. In other examples, the refractory material contains zirconia and is substantially free of zirconia. In still other examples, the refractory material contains a mixture of alumina and zirconia in which the proportion of alumina is greater than the proportion of zirconia. In still further examples, the refractory material contains a mixture of zirconia and alumina in which the proportion of zirconia is greater than the proportion of alumina. The refractory material can be present in an amount of at least about 50 wt %, at least about 55 wt %, at least about 60 wt %, at least about 65 wt %, at least about 70 wt %, at least about 75 wt %, at least about 80 wt %, at least about 85 wt %, at least about 90 wt %, at least about 95 wt %, or at least about 99 wt %. For example, the refractory material can be present in an amount of from about 50 wt % to about 99.9 wt %, about 55 wt % to about 99.9 wt %, about 60 wt % to about 99.9 wt %, about 65 wt % to about 99.9 wt %, about 70 wt % to about 99.9 wt %, about 75 wt % to about 99.9 wt %, about 80 wt % to about 99.9 wt %, about 85 wt % to about 99.9 wt %, about 90 wt % to about 99.9 wt %, about 95 wt % to about 99.9 wt %, about 50 wt % to about 95 wt %, about 55 wt % to about 95 wt %, about 60 wt % to about 95 wt %, about 65 wt % to about 95 wt %, about 70 wt % to about 95 wt %, about 75 wt % to about 95 wt %, about 80 wt % to about 95 wt %, about 85 wt % to about 95 wt %, about 90 wt % to about 95 wt %, about 50 wt % to about 90 wt %, about 55 wt % to about 90 wt %, about 60 wt % to about 90 wt %, about 65 wt % to about 90 wt %, about 70 wt % to about 90 wt %, about 75 wt % to about 90 wt %, about 80 wt % to about 90 wt %, about 85 wt % to about 90 wt %, about 50 wt % to about 85 wt %, about 55wt % to about 85 wt %, about 60 wt % to about 85 wt %, about 65 wt % to about 85 wt %, about 70 wt % to about 85 wt %, about 75 wt % to about 85 wt %, about 80 wt % to about 85 wt %, about 50 wt % to about 75 wt %, about 55 wt % to about 75 wt %, about 60 wt % to about 75 wt %, about 65 wt % to about 75 wt %, about 70 wt % to about 75 wt %, about 50 wt % to about 70 wt %, about 55 wt % to about 70 wt %, about 60 wt % to about 70 wt %, about 65 wt % to about 70 wt %, about 50 wt % to about 65 wt %, about 55 wt % to about 65 wt %, about 60 wt % to about 65 wt %, or about 50 wt % to about 55 wt %.

In some aspects, the refractory material has an average particle diameter d₅₀ of less than about 30 μm. In some aspects, the refractory material has an average particle diameter dso of less than about 30 μm, less than about 25 μm, less than about 20 μm, less than about 15 μm, less than about 10 μm, or less than about 5 μm. For example, the refractory material can have an average particle diameter d₅₀ of from about 1 μm to about 30 μm, about 1 μm to about 25 μm, about 1 μm to about 20 μm, about 1 μm to about 15 μm, about 1 μm to about 10 μm, about 1 μm to about 5 μm, about 5 μm to about 30 μm, about 5 μm to about 25 μm, about 5 μm to about 20 μm, about 5 gm to about 15 μm, about 5 μm to about 10 μm, about 10 μm to about 30 μm, about 10 μm to about 25 μm, about 10 μm to about 20 μm, about 10 μm to about 15 μm, about 15 μm to about 30 μm, about 15 μm to about 25 μm, about 15 μm to about 20 μm, about 20 μm to about 30 μm, about 20 μm to about 25 μm, or about 25 μm to about 30 μm. In some aspects, the refractory material has an average particle diameter dso of about 1 μm, about 5 μm, about 10 μm, about 15 μm, about 20 μm, about 25 μm, about 30 μm, or any particle diameter between these values.

In some aspects, the refractory material is composed of a first plurality of particles having a first average particle diameter dso and a second plurality of particles having a second average particle diameter dso that is different than the first average particle diameter. In some examples, the first plurality of particles has a first average particle diameter d₅₀ of greater than about 10 μm and the second plurality of particles has a second average particle diameter d₅₀ of less than about 10 μm. For example, the first plurality of particles can have a first average particle diameter d₅₀ of greater than about 10 μm, greater than about 15 μm, greater than about 20 μm, or greater than about 25 μm and the second plurality of particles can have a second average particle diameter dso of less than about 10 μm, less than about 7 μm, or less than about 5 μm. In some examples, the first plurality of particles can have a first average particle diameter d₅₀ of about 10 gm to about 30 μm, about 10 μm to about 25 μm, about 10 μm to about 20 μm, about 10 μm to about 15 μm, about 15 μm to about 30 μm, about 15 μm to about 25 μm, about 15 μm to about 20 gm, about 20 μm to about 30 μm, about 20 μm to about 25 μm, or about 25 μm to about 30 μm. In some examples, the second plurality of particles can have a second average particle diameter d₅₀ of from about 1 μm to about 10 μm, about 1 μm to about 7 μm, about 1 μm to about 5 μm, about 5 μm to about 7 μm, about 5 μm to about 10 μm, or about 7 μm to about 10 μm. In one example, the first plurality of particles can have a first average particle diameter d₅₀ of about 20 gm and the second plurality of particles can have a second average particle diameter d₅₀ of about 5 μm. In another example, the first plurality of particles can have a first average particle diameter d₅₀ of about 20 μm and the second plurality of particles can have a second average particle diameter d₅₀ of about 1 μm.

In some aspects, the cement mixture contains less than about 15 wt % titania. In some aspects, the cement mixture can contain less than about 15 wt % titania, less than about 12 wt % titania, less than 10 wt % titania, less than 8 wt % titania, less than 5 wt % titania, or less than 1 wt % titania. For example, the cement mixture can contain titania in an amount of from about 0 wt % to about 15 wt %, about 0 wt % to about 12 wt %, about 0 wt % to about 10 wt %, about 0 wt % to about 8 wt %, about 0 wt % to about 5 wt %, about 0 wt % to about 1 wt %, about 0 wt % to about 0.1 wt %, about 0.1 wt % to about 15 wt %, about 0.1 wt % to about 12 wt %, about 0.1 wt % to about 10 wt %, about 0.1 wt % to about 8 wt %, about 0.1 wt % to about 5 wt %, about 0.1 wt % to about 1 wt %, about 1 wt % to about 15 wt %, about 1 wt % to about 12 wt %, about 1 wt % to about 10 wt %, about 1 wt % to about 8 wt %, about 1 wt % to about 5 wt %, about 5 wt % to about 15 wt %, about 5 wt % to about 12 wt %, about 5 wt % to about 10 wt %, about 5 wt % to about 8 wt %, about 8 wt % to about 15 wt %, about 8 wt % to about 12 wt %, about 8 wt % to about 10 wt %, about 10 wt % to about 15 wt %, about 10 wt % to about 12 wt %, or about 12 wt % to about 15 wt %. In some examples, the cement mixture is substantially free of titania such that the cement mixture is substantially free of titanium.

In some aspects, the cement mixture can contain a pore forming agent. The pore forming agent can be selected from any suitable pore forming agent, non-limiting examples of which include starch, resin, graphite, sulfate, nitrite, nitrate, carbonate, and combinations thereof. The pore forming agent can be present in any suitable amount to provide the plugging material formed by the cement mixture with the desired characteristics (e.g., density, porosity). In some aspects, the pore forming agent can be present in the cement mixture in an amount of from about 0 wt % to about 30 wt %. For example, the pore forming agent can be present in the cement mixture in an amount of from about 0 wt % to about 30 wt %, about 5 wt % to about 30 wt %, about 10 wt % to about 30 wt %, about 15 wt % to about 30 wt %, about 20 wt % to about 30 wt %, about 25 wt % to about 30 wt %, about 0 wt % to about 25 wt %, about 5 wt % to about 25 wt %, about 10 wt % to about 25 wt %, about 15 wt % to about 25 wt %, about 20 wt % to about 25 wt %, about 0 wt % to about 20 wt %, about 5 wt % to about 20 wt %, about 10 wt % to about 20 wt %, about 15 wt % to about 20 wt %, about 0 wt % to about 15 wt %, about 5 wt % to about 15 wt %, about 10 wt % to about 15 wt %, about 0 wt % to about 10 wt %, or about 5 wt % to about 10. In some aspects the cement mixture is substantially free of a pore forming agent.

In some aspects, the cement mixture can comprise an organic binder. Non-limiting examples of suitable organic binders include polyvinyl alcohol, polyvinyl butyral, polyvinyl pyrrolidone, starch, methylcellulose, ethyl hydroxy ethyl cellulose, hydroxy butyl methylcellulose, hydroxy methylcellulose, hydroxypropyl methylcellulose, hydroxyethyl methylcellulose, hydroxybutyl cellulose, hydroxyethyl cellulose, hydroxypropyl cellulose, sodium carboxy methylcellulose, and combinations thereof. In some aspects, the cement mixture contains at least about 0.1 wt % organic binder. In some aspects, the cement mixture contains at least about 0.1 wt %, at least about 0.25 wt %, at least about 0.5 wt %, at least about 0.75 wt %, or at least about 0.9 wt % of the organic binder. For example, the cement mixture can contain the organic binder in an amount of from about 0.1 wt % to about 2 wt %, about 0.1 wt % to about 1.5 wt %, about 0.1 wt % to about 1 wt %, about 0.1 wt % to about 0.9 wt %, about 0.1 wt % to about 0.75 wt %, about 0.1 wt % to about 0.5 wt %, about 0.1 wt % to about 0.25 wt %, from about 0.25 wt % to about 2 wt %, about 0.25 wt % to about 1.5 wt %, about 0.25 wt % to about 1 wt %, about 0.25 wt % to about 0.9 wt %, about 0.25 wt % to about 0.75 wt %, about 0.25 wt % to about 0.5 wt %, from about 0.5 wt % to about 2 wt %, about 0.5 wt % to about 1.5 wt %, about 0.5 wt % to about 1 wt %, about 0.5 wt % to about 0.9 wt %, about 0.5 wt % to about 0.75 wt %, from about 0.75 wt % to about 2 wt %, about 0.75 wt % to about 1.5 wt %, about 0.75 wt % to about 1 wt %, about 0.75 wt % to about 0.9 wt %, from about 0.9 wt % to about 2 wt %, about 0.9 wt % to about 1.5 wt %, about 0.9 wt % to about 1 wt %, or from about 1 wt % to about 2 wt %. In some examples, the organic binder is present in an amount of about 0.1 wt %, about 0.25 wt %, about 0.5 wt %, about 0.6 wt %, about 0.75 wt %, about 0.8 wt %, about 0.9 wt %, about 1 wt %, about 1.5 wt %, about 2 wt %, or any amount between these values.

The cement mixture of the present disclosure can also comprise a liquid vehicle. The liquid vehicle can provide a flow-able or paste-like consistency to the cement mixtures of the present disclosure. In some examples, the liquid vehicle is water, although other liquid vehicles exhibiting solvent action with respect to the organic binder may be used. The amount of the liquid vehicle component can vary in order to impart the desired handling properties and compatibility with the other components in the ceramic batch mixture. The liquid vehicle can be present in an amount of at least about 5 wt %, at least about 10 wt %, at least about 15 wt %, at least about 20 wt %, at least about 25 wt %, at least about 30 wt %, or at least about 40 wt %. For example, the liquid vehicle can be present in an amount of from about 5 wt % to about 50 wt %, about 5 wt % to about 45 wt %, about 5 wt % to about 40 wt %, about 5 wt % to about 35 wt %, about 5 wt % to about 30 wt %, about 5 wt % to about 25 wt %, about 5 wt % to about 20 wt %, about 5 wt % to about 15 wt %, about 5 wt % to about 10 wt %, about 10 wt % to about 50 wt %, about 10 wt % to about 45 wt %, about 10 wt % to about 40 wt %, about 10 wt % to about 35 wt %, about 10 wt % to about 30 wt %, about 10 wt % to about 25 wt %, about 10 wt % to about 20 wt %, about 10 wt % to about 15 wt %, about 15 wt % to about 50 wt %, about 15 wt % to about 45 wt %, about 15 wt % to about 40 wt %, about 15 wt % to about 35 wt %, about 15 wt % to about 30 wt %, about 15 wt % to about 25 wt %, about 15 wt % to about 20 wt %, about 20 wt % to about 50 wt %, about 20 wt % to about 45 wt %, about 20 wt % to about 40 wt %, about 20 wt % to about 35 wt %, about 20 wt % to about 30 wt %, about 20 wt % to about 25 wt %, about 25 wt % to about 50 wt %, about 25 wt % to about 45 wt %, about 25 wt % to about 40 wt %, about 25 wt % to about 35 wt %, about 25 wt % to about 30 wt %, about 30 wt % to about 40 wt %, about 30 wt % to about 35 wt %, or about 35 wt % to about 40 wt %. In some examples, the liquid vehicle is present in an amount of from about 20 wt % to about 50 wt %. In other examples, the liquid vehicle is present in an amount of about 5 wt %, about 10 wt %, about 15 wt %, about 20 wt %, about 25 wt %, about 26 wt %, about 27 wt %, about 28 wt %, about 29 wt %, about 30 wt %, about 31 wt %, about 32 wt %, about 33 wt %, about 34 wt %, about 35 wt %, about 36 wt %, about 40 wt %, about 41 wt %, about 42 wt %, about 43 wt %, about 44 wt %, about 45 wt %, about 50 wt %, or any amount between these values.

In some aspects, the cement mixture can optionally comprise one or more additional components, non-limiting examples of which include sintering agents and an inorganic binder. Non-limiting examples of sintering agents include Na₂CO₃, clay, fused silica, colloidal silica, colloidal alumina, potassium oxide, or combinations thereof. In another example, the cement mixture can comprise an inorganic binder, such as an aqueous dispersion of inorganic particles (e.g., colloidal silica or colloidal alumina).

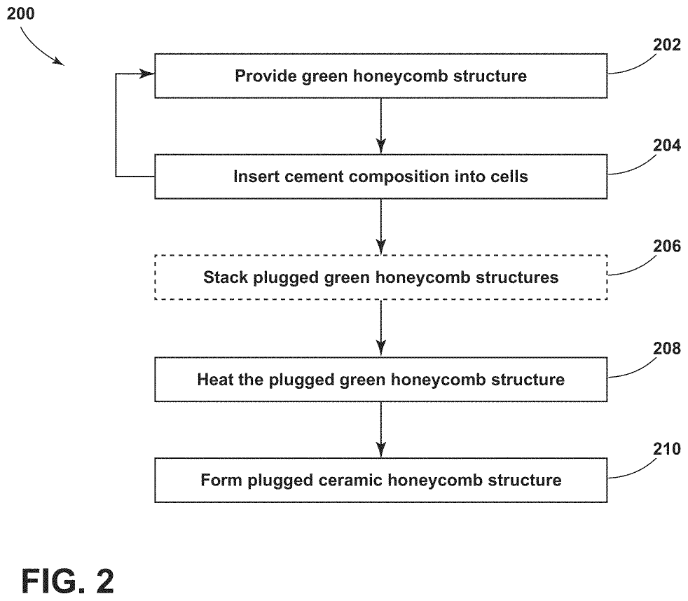

Referring now to FIG. 2, a method 200 for forming a plugged ceramic honeycomb body (e.g., the honeycomb body 100 shown in FIG. 1) is provided. The method 200 comprises a step 202 of creating or otherwise providing a first green honeycomb structure, such as the honeycomb structure 102 (see FIG. 1). As shown in FIG. 1, the honeycomb structure 102 comprises a matrix of intersecting walls 112 which form the inlet cells 108 and outlet cells 110 (also referred to as “channels”) bounded by the walls 112 that extend longitudinally from the first end 104 to the second end 106. For example, the honeycomb structure 102 can be manufactured by extruding a ceramic precursor material through an extrusion die and cutting a green body to a desired length from the extrudate to form each green honeycomb structure 102. In some aspects, the providing step 202 may optionally comprise drying the honeycomb structure 102 to at least partially remove liquid carried by the green honeycomb structure 102 before proceeding to the next step. Non-limiting examples of drying conditions suitable for removing liquid from the green body include heating the green honeycomb structure 102 at a temperature of at least 50° C., at least 60° C., at least 70° C., at least 80° C., at least 90° C., at least 100° C., at least 110° C., at least 120° C., at least 130° C., at least 140° C., or even at least 150° C. for a period of time sufficient to remove the desired amount of liquid. In some examples, the green honeycomb structure 102 can be dried to at least substantially remove liquid from the green honeycomb structure 102. For example, the green honeycomb structure 102 can be dried to remove at least 95%, at least 98%, at least 99%, or even at least 99.9% of liquid carried by the green honeycomb structure 102. Exemplary drying periods can include at least about 1 hour, at least about 2 hours, or even at least about 3 hours.

At step 204, the green honeycomb structure 102 is plugged using the cement mixtures of the present disclosure by inserting the cement mixture into the desired inlet cells 108 and/or outlet cells 110 at the first and/or second ends 104, 106. The cement mixture as described herein can be forced into selected open cells 108, 110 of the green honeycomb structure 102 in a desired plugging pattern and to a desired depth, by one of several conventionally known plugging process methods. For example, selected cells 110 can be end plugged as shown in FIG. 1 to provide a “wall flow” configuration whereby the flow paths resulting from alternate channel plugging direct a fluid or gas stream entering the first end 104 of the exemplified honeycomb structure 102, through the porous ceramic cell walls 112 prior to exiting the honeycomb structure 102 at the second end 106. In one example, the cement mixtures of the present disclosure can be prepared by first blending a source of inorganic particles, an organic binder, and optionally a pore forming agent together to form a base batch mixture. The base batch mixture can be combined with a liquid vehicle and mixed until homogenous. The amount of liquid vehicle can be selected at least in part based on a desired consistency of the cement mixture. For example, the amount of liquid vehicle can be selected to provide a paste or slurry suitable for plugging the desired cells in a particular honeycomb structure. In some aspects, the cement mixtures of the present disclosure can have a cement viscosity, as measured using the ball push test set-up described above, of at least about 0.2 kgf, at least about 0.25 kgf, at least about 0.3 kgf, at least about 0.35 kg, at least about 0.4 kgf, at least about 0.45 kgf, at least about 0.5 kgf, about at least 0.55 kgf, or at least about 0.6 kgf. For example, the cement mixtures of the present disclosure can have a cement viscosity, as measured using the ball push test set-up of from about 0.2 kgf to about 0.8 kgf, about 0.2 kgf to about 0.75 kgf, about 0.2 kgf to about 0.7 kgf, about 0.2 kgf to about 0.65 kgf, about 0.2 kgf to about 0.6 kgf, about 0.2 kgf to about 0.55 kgf, about 0.2 kgf to about 0.5 kgf, about 0.2 kgf to about 0.45 kgf, about 0.2 kgf to about 0.4 kgf, about 0.2 kgf to about 0.45 kgf, about 0.2 kgf to about 0.3 kgf, about 0.25 kgf to about 0.8 kgf, about 0.25 kgf to about 0.75 kgf, about 0.25 kgf to about 0.7 kgf, about 0.25 kgf to about 0.65 kgf, about 0.25 kgf to about 0.6 kgf, about 0.25 kgf to about 0.55 kgf, about 0.25 kgf to about 0.5 kgf, about 0.25 kgf to about 0.45 kgf, about 0.25 kgf to about 0.4 kgf, about 0.25 kgf to about 0.45 kgf, about 0.25 kgf to about 0.3 kgf, about 0.3 kgf to about 0.8 kgf, about 0.3 kgf to about 0.75 kgf, about 0.3 kgf to about 0.7 kgf, about 0.3 kgf to about 0.65 kgf, about 0.3 kgf to about 0.6 kgf, about 0.3 kgf to about 0.55 kgf, about 0.3 kgf to about 0.5 kgf, about 0.3 kgf to about 0.45 kgf, about 0.3 kgf to about 0.4 kgf, about 0.4 kgf to about 0.8 kgf, about 0.4 kgf to about 0.75 kgf, about 0.4 kgf to about 0.7 kgf, about 0.4 kgf to about 0.65 kgf, about 0.4 kgf to about 0.6 kgf, about 0.4 kgf to about 0.55 kgf, about 0.4 kgf to about 0.5 kgf, about 0.4 kgf to about 0.45 kgf, about 0.45 kgf to about 0.8 kgf, about 0.45 kgf to about 0.75 kgf, about 0.45 kgf to about 0.7 kgf, about 0.45 kgf to about 0.65 kgf, about 0.45 kgf to about 0.6 kgf, about 0.45 kgf to about 0.55 kgf, about 0.45 kgf to about 0.5 kgf, about 0.5 kgf to about 0.8 kgf, about 0.5 kgf to about 0.75 kgf, about 0.5 kgf to about 0.7 kgf, about 0.5 kgf to about 0.65 kgf, about 0.5 kgf to about 0.6 kgf, about 0.5 kgf to about 0.55 kgf, about 0.55 kgf to about 0.8 kgf, about 0.55 kgf to about 0.75 kgf, about 0.55 kgf to about 0.7 kgf, about 0.55 kgf to about 0.65 kgf, about 0.55 kgf to about 0.6 kgf, about 0.6 kgf to about 0.8 kgf, or about 0.6 kgf to about 0.75 kgf, about 0.6 kgf to about 0.7 kgf, about 0.6 kgf to about 0.65 kgf, about 0.65 kgf to about 0.8 kgf.

The plugged honeycomb structure 102 formed at step 204 can then be dried and subsequently fired under conditions effective to convert the green body and the plugging material into a primary sintered phase ceramic material at step 208. Conditions effective for drying the cement mixture used as the plugging material at step 204 include those conditions capable of removing at least a portion of the liquid vehicle present within the cement mixture. Examples of non-limiting drying conditions suitable for removing the liquid vehicle include heating the plugged green honeycomb structure at a temperature of at least 50° C., at least 60° C., at least 70° C., at least 80° C., at least 90° C., at least 100° C., at least 110° C., at least 120° C., at least 130° C., at least 140° C., or even at least 150° C. for a period of time sufficient to remove a desired proportion of the liquid vehicle from the cement mixture of the plugging material. In one example, the conditions effective to at least substantially remove the liquid vehicle from the plugging material includes heating the cement mixture at a temperature in the range of from 60° C. to 120° C. for a period of about 2 hours. Further, the heating can be provided by any suitable method, including for example, hot air drying, RF, and/or microwave drying. In some examples, the green honeycomb structure 102 can be dried at step 202, as described above, prior to plugging. In other examples, the plugging material and the green honeycomb structure 102 can be dried together in a single process.

After drying, the plugged honeycomb structure 102 can be fired under conditions effective to convert the green honeycomb structure and the plugging material formed from the cement mixture of the present disclosure into primary sintered phase ceramic mixtures. Firing the green honeycomb structure and the plugging material in the same firing step can be referred to as a “single fire” or a “co-fired” process. The conditions effective to fire the ceramic precursor material of the green honeycomb structure are also effective to convert the cement mixture of the plugging material into a sintered phase ceramic mixture. The conditions effective to single fire the ceramic precursor material of the green honeycomb structure and the cement mixture of the plugging material can include firing the plugged honeycomb structure at a maximum firing temperature in the range of from about 1350° C. to 1500° C., and more preferably at a maximum firing or soak temperature in the range of from about 1375° C. to about 1430° C. In some examples, the maximum firing or soak temperature can be held for a period of time in the range of from about 5 to 30 hours, including exemplary time periods of 10, 15, 20, or even 25 hours. In some examples, the entire firing cycle, including the initial ramp cycle up to the soak temperature, the duration of the maximum firing or soak temperature, and the cooling period can, for example, include a total duration in the range of from about 100 to 150 hours, including 105, 115, 125, 135, or even 145 hours, for example. The features of the firing cycle can be selected based on the ceramic precursor material of the green honeycomb structure and the cement mixture of the plugging material to form a plugged ceramic honeycomb structure 102 at step 210 having the desired sintered phase ceramic mixture and structure.

The fired plugs formed using the cement mixture of the present disclosure can have a plug strength of at least about 10 N. For example, the fired plugs formed using the cement mixture of the present disclosure can have a plug strength of at least about 5 N, at least about 10 N, at least about 15 N, at least about 20 N, or at least 25 N. In some examples, the fired plugs formed using the cement mixtures of the present disclosure can have a plug strength of from about 5 N to about 35 N, about 5 N to about 30 N, about 5 N to about 25 N, about 5 N to about 20 N, about 5 N to about 15 N, about 10 N to about 35 N, about 10 N to about 30 N, about 10 N to about 25 N, about 10 N to about 20 N, about 10 N to about 15 N, about 15 N to about 35 N, about 15 N to about 30 N, about 15 N to about 25 N, about 15 N to about 20 N, about 20 N to about 35 N, about 20 N to about 30 N, about 20 N to about 25 N, or about 25 N to about 35 N.

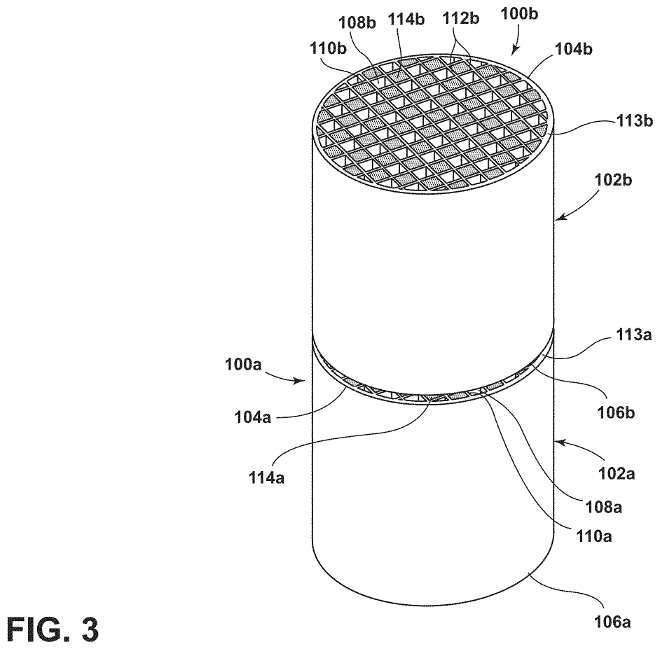

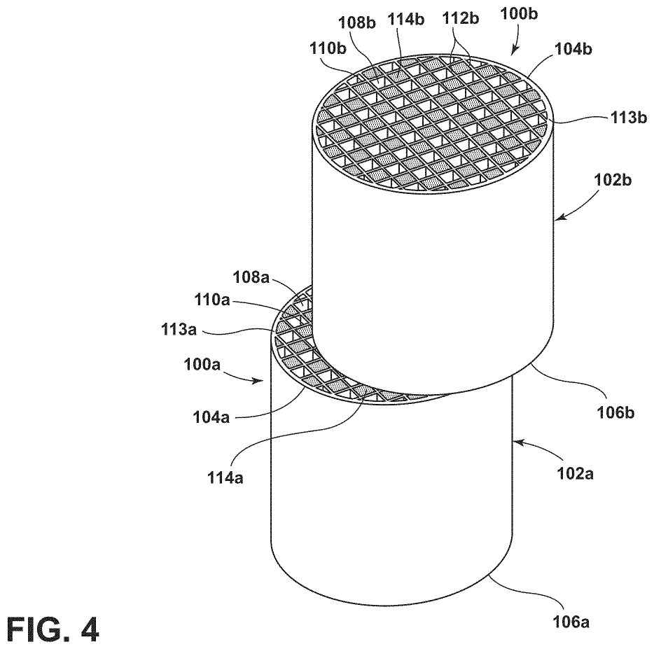

The method 200 can also include an optional step 206 of stacking the plugged green honeycomb structures within the furnace during the firing process of step 208. Stacking the plugged green honeycomb structures 102 allows for a greater number of structures to be fired within the furnace in a given firing process. As illustrated in FIGS. 3 and 4, the plugged green honeycomb structures 102a and 102b can be stacked vertically, end-to-end, within the furnace. The suffix “a” and “b” is used in FIGS. 3 and 4 to differentiate between individual honeycomb structures 102. The plugged green honeycomb structures 102a, 102b, can be stacked such that the second end 106b of the second plugged green honeycomb structure 102b abuts the first end 104a of the first plugged green honeycomb structure 102a. As illustrated in FIG. 3, the plugged green honeycomb structures 102a, 102b can be stacked such that central axis of the first green plugged honeycomb structure 102a is generally aligned with the central axis of the second green plugged honeycomb structure 102b. In this manner, the perimeter wall 113a is generally aligned with the perimeter wall 113b and the cell channels 108a, 110a of the first green honeycomb structure 102a may be generally aligned with the cell channels 108b, 110b of the second green honeycomb structure 102b (cell channels 108a can be generally aligned with any of cell channels 108b and 110b and cell channels 110a can be generally aligned with any of cell channels 108b and 110b ). Alternatively, as illustrated in FIG. 4, the plugged green honeycomb structures 102a, 102b can be stacked such that the central axis of the first green plugged honeycomb structure 102a is offset from the central axis of the second green plugged honeycomb structure 102b. In this manner, the perimeter wall 113b of the second green plugged honeycomb structure 102b is offset from the perimeter wall 113a of the first green plugged honeycomb structure 102a. In some aspects, the first and second green plugged honeycomb structures 102a, 102b can be stacked directly on top of one another such that the second end 106b of the second green plugged honeycomb structure 102b is directly abutting and in direct contact with the first end 104a of the first green plugged honeycomb structure 102a. While only two stacked green plugged honeycomb structures 102a, 102b are illustrated, it is understood that any number of honeycomb structures may be stacked one on top of the other.

When the method 200 comprises the stacking step 206, the step 210 of forming the plugged ceramic structure 102 can comprise separating the fired, stacked first and second plugged ceramic structures 102a and 102b. Separation of the stacked first and second plugged ceramic structures 102a and 102b may be done by hand or with the use of a tool to lift the second structure 102b from the first structure 102a.

Following the formation of the plugged ceramic honeycomb structure 102 at step 210, the plugged ceramic honeycomb structure 102 may optionally be treated according to one or more post-processing treatments. For example, the plugged ceramic honeycomb structure 102 may be treated with a treatment solution, such as a catalyst solution, for example.

According to another embodiment of the present disclosure, the cement mixture of the present disclosure can be used to plug an already fired, ceramic honeycomb structure (referred to as a 2-step firing process or a second firing process). In this embodiment, the green honeycomb structure is fired using effective firing conditions, as described above, to convert the green honeycomb structure into a ceramic honeycomb structure. The fired, ceramic honeycomb structure can then be plugged with the cement mixture of the present disclosure, dried, and then fired, as described above in steps 204-210 of the method 200 of FIG. 2. During firing, the plugged ceramic honeycomb structures can optionally be stacked as described above with respect to step 206 of the method 200.

Aspects of the present disclosure relate to a cement mixture that can be used to plug green body honeycomb structures such that the plugging material and the green body honeycomb structure can be fired in a single fire or co-fired process. Single fire processes may provide cost and/or time saving benefits in some applications compared to a two-step firing process in which the green body honeycomb structure is fired prior to plugging. Optionally, the cement mixtures of the present disclosure can be used to plug a fired, ceramic honeycomb structure.

Further aspects of the present disclosure relate to a cement mixture that can be used to plug a honeycomb structure and which allows the plugged honeycomb structures to be stacked during a firing process and then separated with little force and/or little damage to the parts. Without wishing to be limited by any theory, when conventional plugged honeycomb structures are stacked during firing, portions of the plugging material and/or the honeycomb structure material of one part may bond with adjacent portions of the plugging material and/or the honeycomb structure of an adjacent stacked part (e.g., by sintering during high firing temperatures). When this occurs, separation of the stacked parts may become difficult, requiring strong forces and/or the application of tools to separate the stacked parts. In some cases, this may result in damage to the parts during the separation process (e.g., surface defects, edge chipping, etc.), which may result in a reduced material utilization rate and/or increase processing time and costs. The use of additional material or parts placed between plugged stacked honeycomb structures may decrease the likelihood of sticking, but can add additional costs and labor time to the firing process. The cement mixtures of the present disclosure comprising a plurality of inorganic particles comprising at least about 50 wt % of a refractory material selected from alumina and/or zirconia and less than about 15 wt % titania can be used to form a plugging material that can decrease the degree to which stacked plugged honeycomb structures stick together after firing. Reducing the degree to which stacked plugged honeycomb structures stick together after firing can result in a decrease in the force required to separate the stacked structures and/or a decrease in the damage done to the structures when they are separated. Without wishing to be limited by any theory, it is believed that the high proportion of refractory materials in the cement mixture that have a high sintering temperature, such as alumina and zirconia, may decrease the likelihood of bond formation and/or the strength of bonds formed between stacked honeycomb structures during firing. The alumina and zirconia used in the cement mixtures of the present disclosure have a higher sintering temperature and a larger coefficient of thermal expansion (CTE) than a cordierite-based honeycomb structure, which is believed the contribute to a decrease in the degree of sticking between stacked honeycomb structures during firing. For example, alumina ceramic grog typically has a sintering temperature of about 1650° C. to 1900° C. and a CTE of about 88×10⁻⁷ K⁻¹, whereas conventional cordierite ceramic grog typically has a sintering temperature of about 1450° C. and a CTE of about 2×10⁻⁷ K⁻¹. Zirconia ceramic grog typically has a high sintering temperature of about 1700° C. and a CTE of about 42-105×10⁻⁷ K⁻¹, compared to a cordierite ceramic grog.

### EXAMPLES

The following examples describe various features and advantages provided by the disclosure, and are in no way intended to limit the invention and appended claims.

### Example 1

Table 1 below includes exemplary cement mixture Examples 1A-1B (“Ex. 1A” and “Ex. 1B”) according to the present disclosure that comprise a plurality of inorganic particles comprising greater than 50 wt % of zirconia (Ex. 1A) or alumina (Ex. 1B) and less than 15 wt % titania. Table 1 also includes a comparative cement mixture, Comparative Example 1C (“Comp. Ex. 1C”) that comprises a cordierite ceramic precursor material as the inorganic particle component of the mixture. Ex. 1A comprised zirconia particles having an average particle diameter d₅₀ of about 20 μm, and comprised a small amount of Y₂O₃. Ex. 1B comprised alumina particles having an average particle diameter d₅₀ of about 20 μm. Comp. Ex. 1C comprised cordierite particles having an average particle diameter d₅₀ of about 20 μm. For all three (3) examples Ex. 1A-B and Comp. Ex. 1C, the pore forming agent was starch, the organic binder was methylcellulose, and the liquid vehicle was distilled water.

TABLE 1

| | | Pore Forming | Organic | Liquid |
|---|---|---|---|---|
| Example | Inorganic Particles | Agent | Binder | Vehicle |
| Ex. 1A | 300 g (ZrO₂) | 60 g | 4.50 g | 124.0 g |
| Ex. 1B | 300 g (Al₂O₃) | 60 g | 4.50 g | 127.5 g |
| Comp. | 300 g (cordierite) | 60 g | 4.50 g | 202.5 g |
| Ex. 1C | | | | |

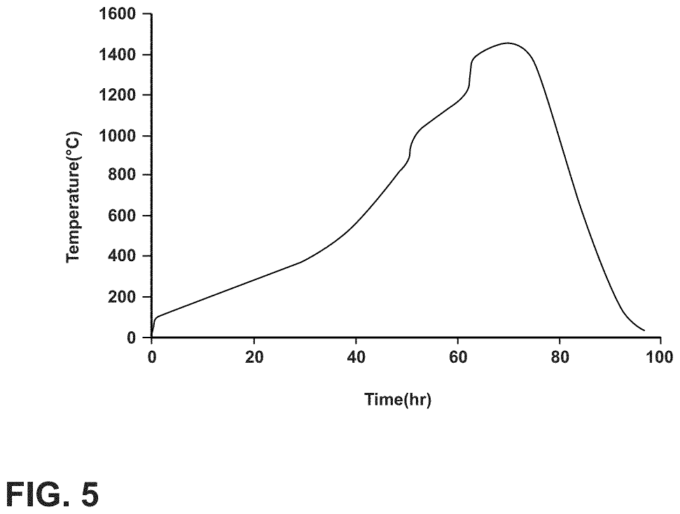

Each of the cement mixtures were mixed and used in a green body plugging process to plug a green body honeycomb structure made from a cordierite ceramic precursor mixture. The cordierite ceramic precursor mixture was extruded to form a honeycomb structure (2 inches in diameter) and a Mylar film was applied to the ends of the extruded green body structure. Holes were burned into the Mylar film to form a mask for plugging a predetermined pattern of cells in the green body honeycomb structure. Each of the cement mixtures were prepared using a kitchen mixer or planetary mixer to combine the components and then push the mixture through the open channels in the mask to form plugged green bodies using an Instron machine. The as-mixed cement mixtures for Ex. 1A, Ex. 1B, and Comp. Ex. 1C had a viscosity, as measured using a ball push test set-up, of 0.67 kgf, 0.53 kgf, and 0.30 kgf, respectively. The green bodies plugged using the cement mixtures Ex. 1A-B and Comp. Ex. 1C were then stacked end-to-end in a furnace for firing such that a plugged green body was stacked on a green body plugged with the same cement mixture. For example, a green body plugged with cement mixture Ex. 1A was stacked on top of another green body plugged with cement mixture Ex. 1A, etc. The stacked parts were then fired to about 1400° C. according to the firing process illustrated in FIG. 5.

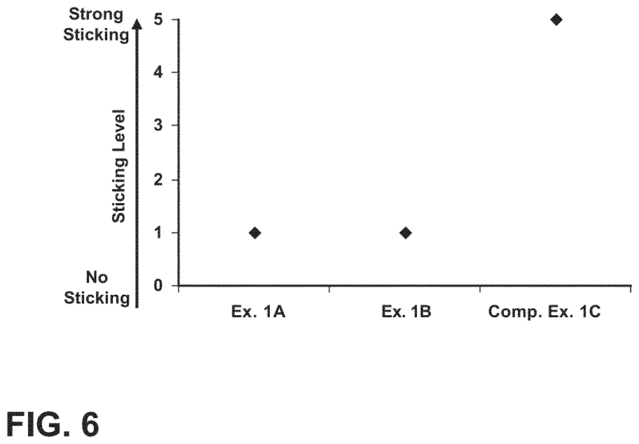

After firing, Ex. 1A-B and Comp. Ex. 1C were evaluated for the degree of sticking between stacked parts. The degree of sticking was evaluated on a relative scale from 0-5, where 0 is indicative of no sticking between fired parts and 5 is indicative of strong sticking between fired parts requiring a strong applied force to separate (e.g., by chiseling and/or putty knife). The degree of sticking for each part was rated as follows: “0” for parts that can be separated by simply lifting one part from the other; “1” for parts separated by mild applied force; “2” for parts separated by mild-moderate applied force; “3” for parts separated by moderate force; “4” for parts separated by moderate-strong applied force; and “5” for parts separated by strong applied force. FIG. 6 illustrates the results of the evaluation of the degree of sticking between the stacked parts for Ex. lA-B and Comp. Ex. 1C after firing. As shown in FIG. 6, parts plugged using the exemplary cement mixtures of Ex. 1A and 1B according to the aspects of the present disclosure showed a low degree of sticking compared to parts plugged using the comparative cement mixture of Comp. Ex. 1C, which required strong applied force to separate.

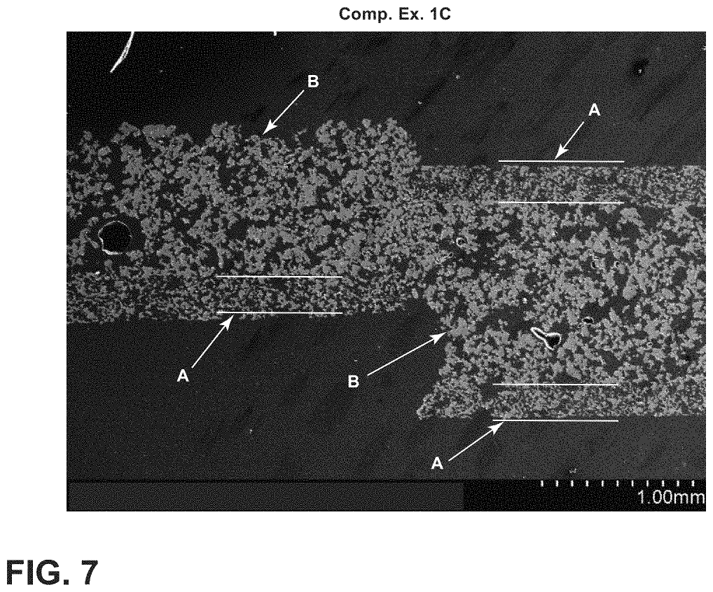

During firing, it is believed that the cement mixture of the plugs will have more expansion than the adjacent web of the honeycomb structure, and may have small gaps between the ends of the stacked parts. Without wishing to be limited by any theory, it is believed that the larger coefficient of thermal expansion (CTE) and sintering temperature of zirconia (Ex. 1A) and alumina (Ex. 1B) compared to cordierite (Comp. Ex. 1C) contributes to the decrease in sticking between stacked parts after firing. The relatively lower degree of sticking for parts plugged with Ex. 1A and Ex. 1B compared to parts plugged with the comparative cement mixture of Comp. Ex. 1C was seen when parts were stacked on center (as illustrated in FIG. 3) and when stacked off-center (as illustrated in FIG. 4). FIG. 7 is a scanning electron microscope (SEM) image of a portion of two stacked parts plugged with the comparative cement mixture of Comp. Ex. 1C. The image is indicative of sintering between the cordierite plugs (arrows “B”) of stacked parts of Comp. Ex. 1C and between the cordierite plugs (arrows “B”) and cordierite web (arrows “A”) of the adjacent stacked parts.

### Example 2

Table 2 below includes exemplary cement mixture Examples 2A-2C (“Ex. 2A,” “Ex. 2B,” and “Ex. 2C”) according to the present disclosure that comprised a plurality of inorganic particles containing greater than 50 wt % alumina and less than about 15% titania (by weight). Ex. 2A-C were prepared and used to green body plug honeycomb structures that were stacked and then fired as described above in Example 1. The degree of sticking of the stacked parts and the plug strength of the plugs for each example was evaluated as described above. Ex. 2A and 2B were made using alumina particles having an average particle diameter d₅₀ of about 5 μm and Ex. 2C was made using alumina particles having an average particle diameter d₅₀ of about 20 μm. Ex. 2A-C contained methylcellulose as the organic binder and distilled water as the liquid vehicle. Ex. 2B and 2C contained pea starch as the pore forming agent. The alumina used for Ex. 2A-C was high purity alumina containing greater than 99 wt % alumina.

TABLE 2

| | d₅₀ | | | Pore | | | | | | Plug |
|---|---|---|---|---|---|---|---|---|---|---|
| | Inorganic | | Inorganic | Forming | | Organic | Liquid | | Degree of | Strength |
| Example | Particles | | Particles | Agent | | Binder | Vehicle | | Sticking | (N) |
| Ex. 2A | 5 | μm | 100 g | 0 | g | 1.5 g | 72 | g | 1 | 26.6 |
| Ex. 2B | 5 | μm | 100 g | 20 | g | 1.5 g | 90 | g | 1 | 16.3 |
| Ex. 2C | 20 | μm | 100 g | 20 | g | 1.5 g | 42.5 | g | 1 | 10 |

The results of Table 2 demonstrate that the difference in average particle diameter dm did not affect the degree of sticking between fired, stacked parts. All of the examples, Ex. 2A-C, demonstrated the ability to separate stacked, fired parts with only mild applied force. In addition, the results of Table 2 indicate that the absence or presence of a pore forming agent, such as pea starch, does not affect the degree of sticking between stacked parts. The results for Ex. 2C, compared to Ex. 2A and 2B, indicate that the presence of the pore forming agent and/or an increase in particle diameter of the alumina may result in a relative decrease in plug strength.

### Example 3

Table 3 below includes exemplary cement mixtures Ex. 3A and 3B according to the present disclosure which utilize different sources for the alumina particles. Ex. 3A-B were prepared and used to green body plug honeycomb structures that were stacked and then fired as described above in Example 1. Both Ex. 3A and 3B comprised alumina particles having an average particle diameter d₅₀ of 20 μm. Ex. 3A-B contained pea starch as the pore forming agent, methylcellulose as the organic binder, and distilled water as the liquid vehicle. Ex. 3A comprised alumina particles from a “low” purity source that contained less than 90 wt % alumina. Ex. 3B comprised alumina particles from a “high” purity source that contained greater than 99 wt % alumina. Table 4 summarizes the content of the source of the alumina particles for Ex. 3A and 3B based on x-ray fluorescence spectroscopy d₅₀ data. The degree of sticking of the stacked parts and the plug strength of the plugs for each example was evaluated as described above.

TABLE 3

| | | Pore | | | Degree | Plug |
|---|---|---|---|---|---|---|
| | Inorganic | Forming | Organic | Liquid | of | Strength |
| Example | Particles | Agent | Binder | Vehicle | Sticking | (N) |
| Ex. 3A | 100 g | 20 g | 0.9 g | 57 g | 1 | 23.4 |
| Ex. 3B | 100 g | 20 g | 1.5 g | 50 g | 1 | 11 |

TABLE 4

| | Low purity | High purity |
|---|---|---|
| | alumina source | alumina source |
| Component (wt %) | Ex. 3A | Ex. 3B |
| Al₂O₃ | 84.84 | 99.74 |
| TiO₂ | 10.73 | — |
| ZrO₂ | 1.23 | — |
| SiO₂ | 0.65 | 0.06 |
| CaO | 0.61 | 0.03 |
| MgO | 0.43 | 0.08 |
| SrO | 0.32 | — |
| CeO₂ | 0.29 | — |
| Fe₂O₃ | 0.26 | 0.01 |
| La₂O₃ | 0.14 | — |
| Na₂O | — | 0.04 |

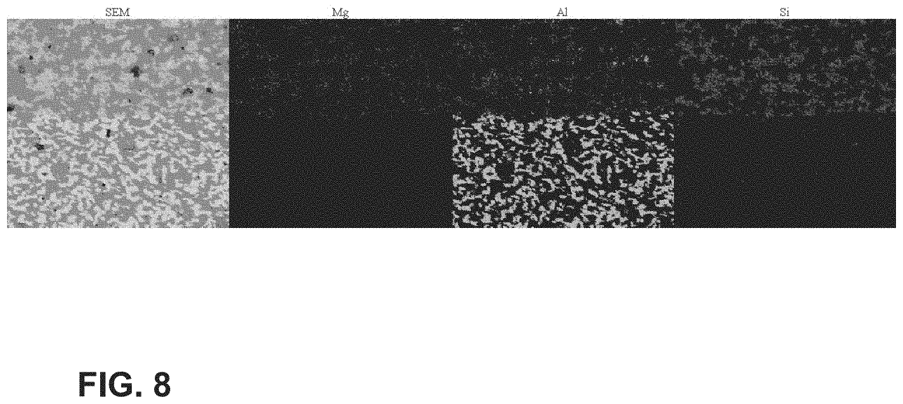

The results of Table 3 indicate that the purity of the source of the alumina particles does not affect the degree of sticking between fired, stacked parts. Both the low purity alumina Ex. 3A and the high purity alumina Ex. 3B exhibited a low degree of sticking requiring only a moderate applied force to separate the parts. The low purity alumina Ex. 3A having a TiO₂ content of about 10 wt % exhibited a higher plug strength than the high purity alumina Ex. 3B, which is substantially free of TiO₂. Without wishing to be limited by any theory, it is believed that the TiO₂ impurity may facilitate sintering of Al₂O₃ to a small extent, which may increase the plug strength. FIG. 8 illustrates an elemental mapping analysis for magnesium (Mg), aluminum (Al), and silicon (Si) obtained using SEM images of the low purity alumina Ex. 3A, which shows no obvious interaction between the honeycomb structure web and the plugging material.

### Example 4

Table 5 below comprises exemplary cement mixtures Ex. 4A-4E according to the present disclosure which utilize different sources of alumina particles having different levels of purity and/or average particle diameter d50. Ex. 4A-4E were prepared and used to green body plug honeycomb structures having a 4.66 inch diameter, which were stacked and then fired in a manner similar to that described above in Example 1. Some duplicate samples of Ex. 4A, 4C, and 4E, were evaluated for stacks of 2 honeycomb structures and some duplicate samples of Ex. 4A, 4B, 4D, and 4E were evaluated for stacks of 3 honeycomb structures. The green body honeycomb structures were plugged with the cement mixtures of Ex. 4A-4E using either a collar or high-speed plugging process (HSP) in TDSO. Parts were oven dried at about 75° C. prior to firing. Ex. 4A-4E each contained pea starch as the pore forming agent, methylcellulose as the organic binder (DuPont METHOCEL™ A4M), and distilled water as the liquid vehicle. In Table 5 below, the term “L-A₂O₃” refers to the low purity alumina source shown in Table 4 for Ex. 3A and the term “H—Al₂O₃” refers to a high purity alumina source containing at least 99 wt % alumina. The colloidal alumina of Ex. 4C has an average particle diameter d50 of about 60 nm to about 90 nm.

TABLE 5

| | L-Al₂O₃ | H-Al₂O₃ | H-Al₂O₃ | | H-Al₂O₃ | Pore | | | | | |
|---|---|---|---|---|---|---|---|---|---|---|---|
| | d₅₀ ~20 | d₅₀ ~20 | d₅₀ ~1 | | d₅₀ ~5 | Forming | | Organic | | Liquid | Colloidal |
| Example | μm | μm | μm | | μm | Agent | | Binder | | Vehicle | Alumina |
| Ex. 4A | | 225 g | 25 | g | | 50 | g | 2.27 | g | 124.5 g | |
| Ex. 4B | 800 g | | | | | 160 | g | 12.00 | g | 435.0 g | |
| Ex. 4C | 800 g | | | | | 160 | g | 12.00 | g | 420.0 g | 40.0 g |
| Ex. 4D | 480 g | | 120 | g | | 120 | g | 9.00 | g | 330.0 g | |
| Ex. 4E | 720 g | | | | 180 g | 180 | g | 13.50 | g | 435.0 g | |

The cement viscosity for the as-mixed cement mixtures (prior to plugging and firing) for Ex. 4B-4E were as follows: 0.67 kgf, 1.08 kgf, 0.47 kgf, and 0.48 kgf, respectively.

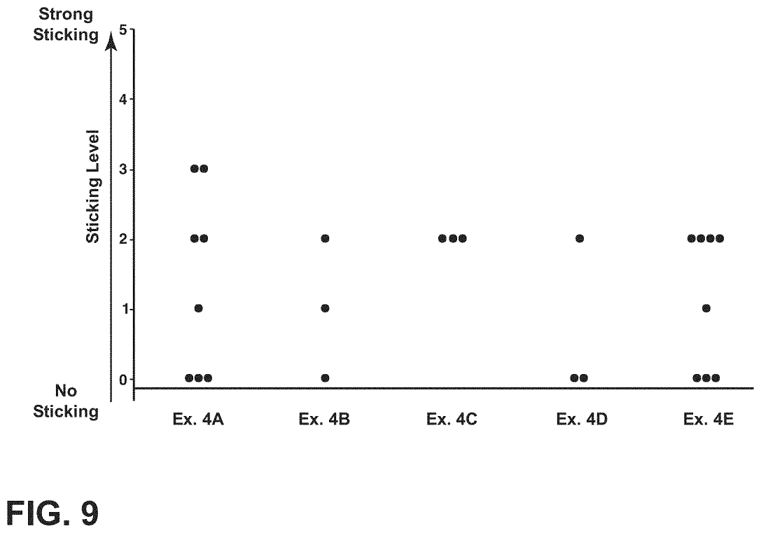

The degree of sticking of the stacked parts for each example was evaluated as described above and the results are illustrated in FIG. 9. The degree of sticking for each part was rated as follows: “0” for parts that can be separated by simply lifting one part from the other; “1” for parts separated by mild applied force; “2” for parts separated by mild-moderate applied force; “3” for parts separated by moderate force; “4” for parts separated by moderate-strong applied force; and “5” for parts separated by strong applied force. As shown in FIG. 9, all of the Ex. 4A-4E were separated with moderate or less applied force and several examples, such as Ex. 4A, 4B, 4D, and 4E, had samples that were separated with mild or less applied force.

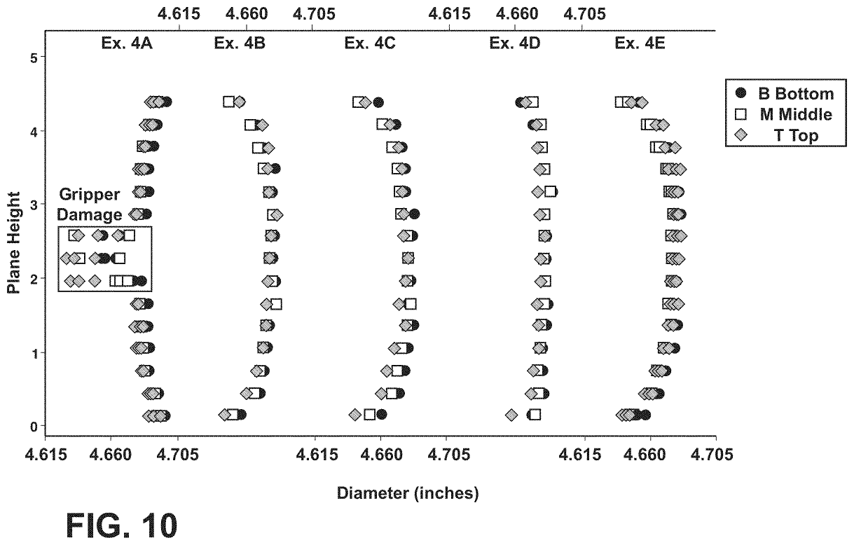

The dimensional stability of Ex. 4A-4E was also evaluated and the results are illustrated in FIG. 10. The data in FIG. 10 indicates that the degree of deformation of the stacked parts after separation was minimal and within acceptable levels for conventional wall flow filters.

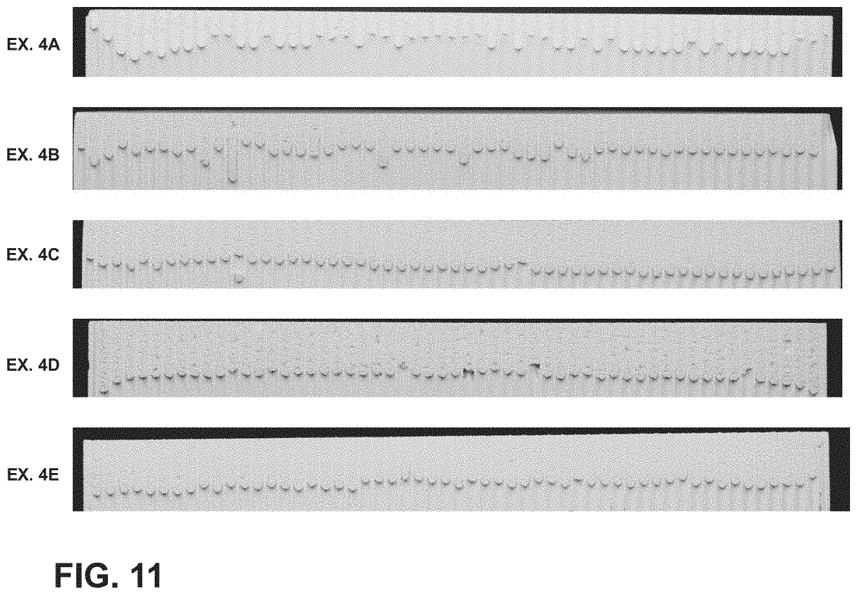

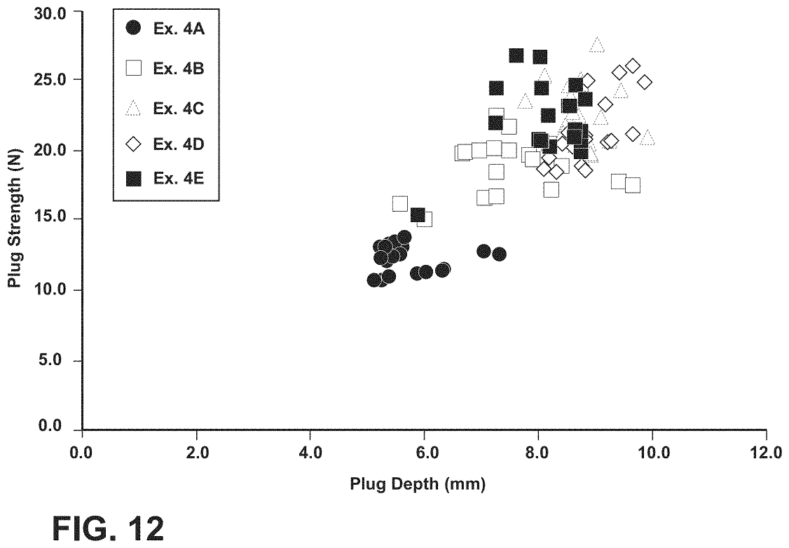

Referring now to FIGS. 11 and 12, FIG. 11 illustrates cross-sections of plugs for each of Ex. 4A-4E and FIG. 12 illustrates the plug strength as a function of plug depth for each example. The data in FIG. 11 indicates that the cement mixtures of Ex. 4A-4E can be used to provide plugs having at least a good quality, with minimal evidence of dimples or voids. As shown in FIG. 12, the cement mixtures of Ex. 4A-4E were used to form plugs having a depth of from about 5 mm to about 10 mm, with a plug strength in the range of about 10 N to 28 N. For example, samples made using Ex. 4D showed the least dimensional change (as shown by the data in FIG. 10) and could be used to form plugs having a depth of about 7 mm to 9 mm and a plug strength of about 20 N to about 27 N, which is suitable for many conventional wall flow filter applications.

The following non-limiting aspects are encompassed by the present disclosure. To the extent not already described, any one of the features of the first through the twenty-third aspect may be combined in part or in whole with features of any one or more of the other aspects of the present disclosure to form additional aspects, even if such a combination is not explicitly described.

According to a first aspect of the present disclosure, a cement mixture for application to a honeycomb body comprises: a plurality of inorganic particles comprising at least about 50% of a refractory material selected from at least one of alumina and zirconia and less than about 15% titania (by weight); a pore forming agent; an organic binder; and a liquid vehicle.

According to a second aspect of the present disclosure, the cement mixture of aspect 1, wherein the plurality of inorganic particles comprises from about 65% to about 95% of the refractory material (by weight).

According to a third aspect of the present disclosure, the cement mixture of aspect 1 or aspect 2, wherein the plurality of inorganic particles comprises less than about 10% titania (by weight).

According to a fourth aspect of the present disclosure, the cement mixture of aspect 1 or aspect 2, wherein the plurality of inorganic particles is substantially free of titania.

According to a fifth aspect of the present disclosure, the cement mixture of any one of aspects 1-4, wherein the plurality of inorganic particles comprises a refractory material having an average particle diameter d₅₀ of less than about 30 μm.

According to a sixth aspect of the present disclosure, the cement mixture of any one of aspects 1-5, wherein the refractory material comprises a first plurality of particles having an average particle diameter d50 of greater than about 10 μm and a second plurality of particles having an average particle diameter d50 of less than about 10 μm.

According to a seventh aspect of the present disclosure, the cement mixture of any one of aspects 1-6, wherein the refractory material comprises alumina.

According to an eighth aspect of the present disclosure, the cement mixture of any one of aspects 1-7, wherein the pore forming agent comprises at least one material selected from a starch, resin, graphite, sulfate, nitrite, nitrate, and carbonate.

According to a ninth aspect of the present disclosure, the cement mixture of any one of aspects 1-8, wherein the organic binder comprises at least one material selected from polyvinyl alcohol, polyvinyl butyral, polyvinyl pyrrolidone, starch, methylcellulose, ethyl hydroxy ethyl cellulose, hydroxy butyl methylcellulose, hydroxy methylcellulose, hydroxypropyl methylcellulose, hydroxyethyl methylcellulose, hydroxybutyl cellulose, hydroxyethyl cellulose, hydroxypropyl cellulose, and sodium carboxy methylcellulose.

According to a tenth aspect of the present disclosure, a honeycomb body comprises: a honeycomb structure that comprises intersecting porous walls of a ceramic material that define channels extending from a first end to a second end; a plugging material disposed in at least a portion of the channels and at least one of the first end and second end, wherein the plugging material comprises at least about 50% of a refractory material selected from at least one of alumina and zirconia (by weight) and less than about 15% titania (by weight).

According to an eleventh aspect of the present disclosure, the honeycomb body of aspect 10, wherein the plugging material is derived from a ceramic mixture, the ceramic mixture comprising: a plurality of inorganic particles comprising at least about 50% of the refractory material and less than about 15% titania (by weight); a pore forming agent; an organic binder; and a liquid vehicle.

According to a twelfth aspect of the present disclosure, the honeycomb body of aspect 10 or aspect 11, wherein the ceramic material comprises at least one of alumina, cordierite, aluminum titanate, and silicon carbide.

According to a thirteenth aspect of the present disclosure, the honeycomb body of any one of aspects 10-12, wherein the plugging material, as disposed in at least a portion of the channels and at least one of the first end and second end, comprises a plug strength of at least about 10 N.

According to a fourteenth aspect of the present disclosure, the honeycomb body of any one of aspects 10-13, wherein the plugging material is substantially free of titania.

According to a fifteenth aspect of the present disclosure, the honeycomb body of any one of aspects 10-14, wherein the refractory material is alumina.

According to a sixteenth aspect of the present disclosure, a method of forming a plugged ceramic honeycomb body comprises: providing a first green honeycomb structure comprising intersecting walls of a ceramic precursor material that define channels extending from a first end to a second end, wherein the ceramic precursor material comprises an aluminum containing oxide; selectively inserting a cement mixture into at least one of the first end and second end of the first green honeycomb structure to form a first plugged green honeycomb structure, wherein the cement mixture comprises at least about 50% of a refractory material selected from at least one of alumina and zirconia (by weight) and less than about 15% titania (by weight); and heating the first plugged green honeycomb structure to a first temperature to convert the ceramic precursor material and the cement mixture into a sintered phase ceramic material to form a first plugged ceramic honeycomb structure.

According to a seventeenth aspect of the present disclosure, the method of aspect 16, wherein prior to the step of heating the first plugged green honeycomb structure, the method further comprises: providing a second green honeycomb structure comprising intersecting walls of the ceramic precursor material that define channels extending from a first end to a second end; selectively inserting the cement mixture into at least one of the first end and second end of the second green honeycomb structure to form a second plugged green honeycomb structure; and stacking the second green honeycomb body on the first green honeycomb structure such that one of the first and second ends of the second green honeycomb structure abuts one of the first and second ends of the first green honeycomb structure, and wherein the step of heating the first plugged green honeycomb structure comprises heating the ceramic precursor material and the cement mixture of the respective stacked first and second plugged green honeycomb structures to form first and second plugged ceramic honeycomb structures.

According to an eighteenth aspect of the present disclosure, the method of aspect 17, wherein subsequent to the step of heating the stacked first and second plugged green honeycomb structures, the method further comprises: manually separating the second plugged ceramic honeycomb structure from the first plugged ceramic honeycomb structure.

According to a nineteenth aspect of the present disclosure, the method of aspect 17, wherein the step of stacking the second green honeycomb body on the first green honeycomb structure comprises aligning the channels of the second green honeycomb body with the channels of the first green honeycomb body.

According to a twentieth aspect of the present disclosure, the method of aspect 17, wherein the step of stacking the second green honeycomb body on the first green honeycomb structure comprises placing the second green honeycomb body in direct contact with the first green honeycomb body.

According to a twenty-first aspect of the present disclosure, the method of any one of aspects 16-20, wherein the cement mixture comprises from about 65% to 95% of the refractory material (by weight).

According to a twenty-second aspect of the present disclosure, the method of any one of aspects 16-21, wherein the refractory material is alumina.

According to a twenty-third aspect of the present disclosure, the method of any one of aspects 16-22, wherein the cement mixture is substantially free of titania.

While exemplary embodiments and examples have been set forth for the purpose of illustration, the foregoing description is not intended in any way to limit the scope of the disclosure and appended claims. Accordingly, variations and modifications may be made to the above-described embodiments and examples without departing substantially from the spirit and various principles of the disclosure. All such modifications and variations are intended to be included herein within the scope of this disclosure and protected by the following claims.

To the extent not already described, the different features of the various aspects of the present disclosure may be used in combination with each other as desired. That a particular feature is not explicitly illustrated or described with respect to each aspect of the present disclosure is not meant to be construed that it cannot be, but it is done for the sake of brevity and conciseness of the description. Thus, the various features of the different aspects may be mixed and matched as desired to form new aspects, whether or not the new aspects are expressly disclosed.

What is claimed is:

1. A plugging cement mixture for application to a honeycomb body, the cement mixture comprising:
a plurality of inorganic particles comprising at least about 50% of a refractory material selected from at least one of alumina and zirconia and less than about 15% titania (by weight);
a pore forming agent;
an organic binder; and
a liquid vehicle.

2. The cement mixture of claim 1, wherein the plurality of inorganic particles comprises from about 65% to about 95% of the refractory material (by weight).

3. The cement mixture of claim 2, wherein the plurality of inorganic particles comprises less than about 10% titania (by weight).

4. The cement mixture of claim 2, wherein the plurality of inorganic particles is substantially free of titania.

5. The cement mixture of claim 2, wherein the plurality of inorganic particles comprises a refractory material having an average particle diameter d₅₀ of less than about 30 μm.

6. The cement mixture of claim 5, wherein the refractory material comprises a first plurality of particles having an average particle diameter dso of greater than about 10 μm and a second plurality of particles having an average particle diameter dso of less than about 10 μm.

7. The cement mixture of claim 6, wherein the refractory material comprises alumina.

8. The cement mixture of claim 7, wherein the pore forming agent comprises at least one material selected from a starch, resin, graphite, sulfate, nitrite, nitrate, and carbonate.

9. The cement mixture of claim 8, wherein the organic binder comprises at least one material selected from polyvinyl alcohol, polyvinyl butyral, polyvinyl pyrrolidone, starch, methylcellulose, ethyl hydroxy ethyl cellulose, hydroxy butyl methylcellulose, hydroxy methylcellulose, hydroxypropyl methylcellulose, hydroxyethyl methylcellulose, hydroxybutyl cellulose, hydroxyethyl cellulose, hydroxypropyl cellulose, and sodium carboxy methylcellulose.

10. A particulate filter comprising:
a honeycomb structure that comprises a matrix of intersecting porous walls of a ceramic material that define channels extending from a first end to a second end;
a plugging material disposed in at least a portion of the channels and at least one of the first end and second end, wherein the plugging material comprises at least about 50% of a refractory material selected from at least one of alumina and zirconia (by weight) and less than about 15% titania (by weight).

11. The particulate filter of claim 10, wherein the plugging material is derived from a ceramic mixture, the ceramic mixture comprising:
a plurality of inorganic particles comprising at least about 50% of the refractory material and less than about 15% titania (by weight);
a pore forming agent;
an organic binder; and
a liquid vehicle.

12. The particulate filter of claim 11, wherein the ceramic material comprises at least one of alumina, cordierite, aluminum titanate, and silicon carbide.

13. The particulate filter of claim 12, wherein the plugging material, as disposed in at least a portion of the channels and at least one of the first end and second end, comprises a plug strength of at least about 10 N.

14. The particulate filter of claim 13, wherein the plugging material is substantially free of titania.

15. The particulate filter of claim 14, wherein the refractory material is alumina.

16. A method of forming a plugged ceramic honeycomb body, the method comprising:
selectively inserting a cement mixture into at least one of a first end and second end of a first green honeycomb structure to form a first plugged green honeycomb structure, wherein the first green honeycomb structure comprises intersecting walls of a ceramic precursor material that define channels extending from a first end to a second end, wherein the ceramic precursor material comprises an aluminum containing oxide, and wherein the cement mixture comprises at least about 50% of a refractory material selected from at least one of alumina and zirconia (by weight) and less than about 15% titania (by weight); and
heating the first plugged green honeycomb structure to a first temperature to convert the ceramic precursor material and the cement mixture into a sintered phase ceramic material to form a first plugged ceramic honeycomb structure.

17. The method of claim 16, wherein prior to the step of heating the first plugged green honeycomb structure, the method further comprises:
providing a second green honeycomb structure comprising intersecting walls of the ceramic precursor material that define channels extending from a first end to a second end;
selectively inserting the cement mixture into at least one of the first end and second end of the second green honeycomb structure to form a second plugged green honeycomb structure; and
stacking the second green honeycomb body on the first green honeycomb structure such that one of the first and second ends of the second green honeycomb structure abuts one of the first and second ends of the first green honeycomb structure, and
wherein the step of heating the first plugged green honeycomb structure comprises heating the ceramic precursor material and the cement mixture of the respective stacked first and second plugged green honeycomb structures to form first and second plugged ceramic honeycomb structures.

18. The method of claim 17, wherein subsequent to the step of heating the stacked first and second plugged green honeycomb structures, the method further comprises:
manually separating the second plugged ceramic honeycomb structure from the first plugged ceramic honeycomb structure.

19. The method of claim 17, wherein the step of stacking the second green honeycomb body on the first green honeycomb structure comprises aligning the channels of the second green honeycomb body with the channels of the first green honeycomb body.

20. The method of claim 17, wherein the step of stacking the second green honeycomb body on the first green honeycomb structure comprises placing the second green honeycomb body in direct contact with the first green honeycomb body.
